(19) United States
(12) Patent Application Publication
(10) Pub. No.: US 2008/0214805 A1
(43) Pub. Date: Sep. 4, 2008

(54) Process For the Preparation of Vulnerable Oils

(76) Inventors: Maha Mohamed Adel Misbah, Vlaardingen (NL); Otto Eduard Rosier, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/885,985

(22) PCT Filed: Feb. 16, 2006
(86) PCT No.: PCT/EP2006/001543

§ 371 Date: Sep. 7, 2007

(30) Foreign Application Priority Data
Mar. 8, 2005 (EP) 05075570.1

(51) Int. Cl. C11B 3/08

(52) U.S. Cl. 544/181

(57) ABSTRACT

Process for the preparation of vulnerable oil wherein degummed and neutralized vulnerable oil is subjected to bleaching and thereafter subjected to filtration, characterized in that in the process one or more, preferably two or more, more preferably three or more and most preferably all four of the following steps a)-d) are included: a) bleaching involves both a wet step and a dry step; b) filtration is conducted in re-circulation until the filtrate has a turbidity of 0.2 FTU or less, preferably 0.1 FTU or less, before filtration of the vulnerable oil is commenced; c) after filtration the vulnerable oil is subjected to a second filtration to a turbidity of 0.1 FTU or less; d) the deodorization is conducted at a temperature of 190° C. or less until 5-20, preferably 8-20 m3 gas/kg oil is passed through the vulnerable oil.

### FIELD OF THE INVENTION

The present invention relates to a process for the preparation of food grade vulnerable oils, in particular marine oils and/or microbial oils and concentrates thereof.

### BACKGROUND TO THE INVENTION

It is well known that these vulnerable oils, in particular microbial oils and marine oils/concentrates, are free of odor and smell when fresh, but reversion through oxidation occurs very rapidly. Many attempts have been made to stabilize the oils by the addition of anti-oxidants or even binary or ternary anti-oxidant systems. However, all anti-oxidant systems do not prevent marine oils get a fishy smell and taste (off-taste) within a period of time. Accordingly there is a need for a process by means of which such marine oils can be stabilized over a long period of time in a simple and economical way whereby even after a long storage time no fishy taste and smell occur. Reduction of off-taste increases the keepability of the vulnerable oil.

### SUMMARY OF THE INVENTION

It is therefore an object of the invention to improve reduce the off-taste and/or improve the keepability of vulnerable oil. We have found that many factors during the processing of these oils are of influence, and thus we found that the object is attained according to the invention which provides a process for the preparation of vulnerable oil wherein degummed and/or neutralised vulnerable oil is subjected to bleaching and thereafter subjected to filtration, characterized in that the filtration is conducted until the filtrate has a turbidity of 0.2 FTU or less.

Preferably the process of the invention comprises one or more, preferably two or more, more preferably three or more and most preferably all four of the following steps a)-d) are included:
a) bleaching involves both a wet step and a dry step
b) filtration is conducted in re-circulation until the filtrate has a turbidity of 0.2 FTU or less, preferably 0.1 FTU or less, before filtration of the vulnerable oil is commenced
c) the deodorization is conducted at a temperature of 190° C. or less until 5-20, preferably 8-20 m3 gas/kg oil is passed through the vulnerable oil.
d) after filtration the vulnerable oil is subjected to a second filtration to a turbidity of 0.1 FTU or less.

### DETAILED DESCRIPTION OF THE INVENTION

The oil prepared according to the invention is a vulnerable oil i.e. an oil which is easily oxidized, developing off-taste. Examples of vulnerable oils are: linseed oil, fish oils, or microbial oils as algae oil, obtained from marine micro algae. Preferably the vulnerable oil has an iodine value of 100 or more, more preferably 120 or more. Preferably the vulnerable oil has a C20+C22 content of 1 wt. % or more. More preferably the vulnerable oil is fish oil, such as oil from Tuna, Herring, Menhaden, Codliver, Skipjack or concentrates made thereof.

Vulnerable oils as used in the present invention are neutralized according to well-known procedures like neutralization to remove the free fatty acids, bleaching to remove colored components and contaminants, and deodorization to remove odiferous components. Variations on the existing procedures are also well known. Fatty acids can also be physically removed by means of a short path distillation equipment. The bleaching step can also be carried out in various manners. Silica, carbon and bleaching earth in various grades and concentrations are frequently used in the bleaching step.

Below the critical steps of the process according to the invention, i.e bleaching, filtration and deodorization are described in more detail. These descriptions should always be taken in connection with the claimed process, in which at least one of features a) to d) described above should be present.

The process according to the invention may be used to treat degummed and neutralized vulnerable oils, e.g. fish oil or marine oil. It may also be used to treat such vulnerable oils which are compositions containing vulnerable oil or concentrates of vulnerable oils. Preferred concentrates are those having a higher content of long chain polyunsaturated fatty acid and/or a lower content of saturated fatty acids than the vulnerable oils from which they were prepared. These may also advantageously be treated according to the process of the invention. Concentrates may be prepared according to known techniques, e.g. fractionation and interesterification, preferably selective enzymatic hydrolysis followed by fatty acid removal and enzymatic interesterification. The preparation of fish oil concentrates is e.g. described in WO97/19601. An example of commercially available marine oil concentrates is the Marinol® range sold by Loders Croklaan, Lipid Nutrition.

Compositions including vulnerable oils include for instance the oil/fat compositions used in the preparation of oil containing food products.

Preferably the process according to the invention is used twice for concentrates and compositions, i.e. both during the preparation of the marine oils to be used to prepare the concentrate or composition and in the purification of the concentrate or composition.

The process according to the invention may be conducted in continuous fashion or batch wise, preferably the process is conducted batch-wise.

Weight percentages (wt. %) are herein calculated relative to the total weight of an (oil) composition, unless otherwise indicated.

### Bleaching

The critical parameters to avoid the fines problem are:
the presence of citric acid and
the amount of water.

The bleaching may be conducted in conventional way. For instance, during the bleaching step 0.1-10 wt. % bleaching powder is added to the vulnerable oil and the mixture is stirred and thereafter filtered. Conventionally, the filtered oil is ready to be deodorized when it is transparent for the eye. Many bleaching powders have been processed with acids or treated at high temperatures, to obtain a high surface area and thus have a very fine particle size.

Preferably the bleaching is conducted as a wet/dry process, i.e. involving a wet step and a dry step. It is important that a sufficiently long wet step is included, and the temperature during the wet step is not too high. The wet step is essential for agglomeration of the bleaching particles. The acid is essential to complex metals. If the wet step is too short of conducted at too high temperature (so that the water evaporates), bleaching agglomerates will break up and the product will contain more fines. Preferably the wet step is conducted in the presence of 0.04-0.14 wt. % water and citric acid. More preferably after addition of 0.02-0.07 wt. % citric acid (as a concentrated solution of 50%) 0.04-0.14 wt. % water is added.

### Filtration

The filtration may be conducted in conventional way. The filtration is usually carried out in a vertical leaf filter or any other filter which can hold substantial amounts of bleaching earth. Preferably a security filter is installed in case that the filter cake breaks a suddenly looses bleaching earth. This security filter is not meant to filter very fine particles, but is installed only as security filter. In general, the filtration process according to the invention exists of 3 separate steps:
black run (oil+bleaching earth is re-circulated over the filter until the turbidity meter shows the turbidity is below 0.2 FTU)
main filtration (all filtered oil is below 0.2 FTU)
rest filtration (filter will be emptied, the risk for particles is high)

The oil from the main filtration passes the security filter

In case that the filtration process is not monitored by optical equipment, the filtered oil is visually checked. Trained people take a sample and judge the oil on clarity with their eyes. However advantageously the filtration process is monitored by optical equipment. In such case optical equipment take over filtration control. Examples of such equipment are: Optek or Monitek analysers. These analysers/techniques measure turbidity, expressed as FTU and this are able to measure the presence of particles of various kinds of bleaching earth.

### Second Filtration/Polishing

Preferably there is a second filtration. This may remove some or all of the (last traces of) oil insoluble substances. It may comprise clarifying the oil, for example using a candle or a (cartridge) filter. Preferably, the second filtration is conducted with a polish filter having a pore diameter of 0.1-5 micrometer.

In the known refining techniques some bleaching earth fines always remain in the oil after filtration. It is common use that the oils when leaving the bleaching vessel are polished (means fine filtration) with a polish filter. Such filters are not appropriate to remove bleaching earth fines because the filter size is 10-50 um. A filter having a pore size of 0.02-10 um, preferably 0.2-1.0 um is preferably used to remove all the fines. The filter may be installed after the deodorizer or bleacher.

It has now surprisingly been found that the marine oil bleached, filtered and deodorized in the usual will still contain very small particles. These particles are not recognized by the human eye of trained persons but are recognized by optical instruments or nephelometers.

After the removal of invisible bleaching earth fines, marine oils have better taste and keep ability. Marine oils and microbial oils contain long chain polyunsaturated fatty acids (LCPUFA) like EPA and DHA. These LCPUFA contain 5 or 6 double bonds which render them prone to atmospheric oxidation accompanied by a fishy taste and smell.

### Deodorization

Deodorization may be conducted in conventional way using steam or inert gas, such as nitrogen in conventional deodorization vessels.

In deodorisation physical mechanisms play a role in the removal of undesired compounds from the oil.

The key parameters which govern the physical removal processes are:
deodorisation temperature
volume of steam dosed per kilogram of oil

The physical removal is achieved by the transfer of compounds with sufficiently high volatility from the oil to the vapor phase (steam). The volatility (vapor pressure) of a compound increases exponentially with temperature. At a given temperature the amount of a compound which can be removed via the vapor phase depends on the volume of vapor phase (steam) which is dosed per amount of oil. Given by the ideal gas law the volume of steam is a function of the temperature and the headspace pressure.

Consequently, the total volume of steam dosed during deodorization is determined by the deodorization time, temperature and pressure, the steam mass flow rate and the heating and cooling profiles. At 180° C. the recommended volume amounts 15 m3/kg of oil. This volume equals 1% steam per hour during 5 h.

Preferably, the deodorization in step d) is conducted using a steam flow though the vulnerable oil. Preferably, the steam flow is a flow of superheated steam produced by heating of de-mineralized water, which has been stripped with nitrogen. Preferably, at the end of deodorization, after the steam flow is stopped, 10-30 mg/kg oil of citric acid is added to the deodorized oil, when the oil has a temperature of 80-110° C.

Preferably, after steam flow is stopped, nitrogen of at least 99.9% purity is flushed through the vulnerable oil.

Preferably the valve in the vapor line from the deodorizer to condenser should be closed in order to avoid back flush of off-flavors. In case that no valve is available the deodorizer is preferably filled with nitrogen in such a way that the off-flavours collected in the condensor/vacuum system cannot return to the oil deodorized. The nitrogen flow should be in one direction without distortion

### Preferred Filling Procedure

The deodorizer oil should preferably collected in coated containers under N₂. The container should be preferably be pre-flushed with N₂ until the residual O₂ concentration does not exceed 0.5% O₂ (air contains 20.9% O₂). Closed containers equipped with a filling opening and a de-aeration opening are suitable containers. Once the container is pre flushed with N₂, the fish oil may flow in the container. The filling tube is located just a few cm above the oil surface to exclude O₂ (if any left). The containers should be filled with as less as possible headspace. When the container is full, the filling opening is closed and N₂ flushing is continued for at least 5 minutes. The N₂ tube is withdrawn and the container is closed. The oil is now protected against oxidation.

The invention will now be illustrated in the following examples, which however should not be construed to limit the scope of the invention.

### EXAMPLES

### Turbidity Measurement

In this application the model Optek 516/TF16 is used as turbidity meter. The Optek turbidimeter model 516/TF16 is a very precise dual beam scattered light photometer. It uses the forward scattered light (11°) in order to detect particle contents in oils. The system consists of two components interconnected with cables the converter type 516 and the sensor type TF16. The equipment is able to detect low amounts of bleaching earth.

The TF16 sensor, manufactured in stainless steel, is designed for inline operation but is modified for off-line use. With respect to example 1-4 The TF16 sensor was calibrated with bleaching earth. The zero point was set by using very clean oil (filtered over Millipore filtration equipment with a filtration sheet of 0.22 um) and adjusting the equipment to zero. A calibration line was obtained by dispersing increasing amounts of bleaching earth in (Tonsil standard) oil which was previously filtered over a Millipore filtration equipment. 1-10 mg bleaching earth was dispersed and the readout was measured. The data were put in a graph. Samples with an unknown amount of bleaching earth were measured and the data were compared with the calibration line to obtain a figure for the bleaching earth. The area of 0-10 mg/kg bleaching earth is in particular relevant for this example.

With respect to example 5 the same equipment was used but another expression of turbidity was used. In general the turbidity is expressed as units formazine (FTU). This is an international standard and can be applied for any turbidity measurement. This standard can also be used on any turbidity equipment provided the equipment is able to measure in low area of 0-0.4 FTU. A calibration line was prepared with formazine from 0-0.8 FTU. 0.4 FTU resembles ˜5 mg bleaching earth. The oil in this invention preferably should have a turbidity of less than 0.2 ftu after the bleaching/filtration and less than 0.1 FTU after the deodorization.

Approx. 150 ml of oil of 80° C. is poured into the measuring chamber. The turbidity is shown on the display of the equipment. Some scattering may occur by the presence of air bubbles. But after 1-2 minutes the measurement becomes stable. The lowest readout is taken as turbidity.

### Examples 1-4

Four containers of fish oil were bought and tasted.

Bleaching earth fines was also measured in the same sample. The sample with the highest amount of bleaching fines turned out to be the worst, whereas the cleanest sample tasted the best. The complete removal of residual bleaching earth is the key to obtain very stable marine oils. Taste was evaluated by a panel of four experienced tasters.

TABLE 1
Examples 1-4, free fatty acid (FFA) content, Iron (Fe)
content, taste evaluation, amount of fines (mg/kg) and
recalculated as fines of bleaching earth in oil.

| | Example | | | |
|---|---|---|---|---|
| | 1 | 2 | 3 | 4 |
| FFA (wt. %) | 0.23 | 0.23 | 0.14 | 0.28 |
| Fe | 0.057 | 0.026 | 0.0 | 0.057 |
| Taste | Fish taste | weak fish | strong fish | Weak fish |
| | (3) | taste (2) | taste (4) | taste (2) |
| | Weak fish | no fish | | very weak |
| | taste (1) | taste (2) | | fish taste |
| | | | | (2) |
| Taste*(average) | 2.5 | 1 | 4 | 1.5 |
| Measured value | 1.2 | 0.8 | 3 | 2 |
| (mg/kg) | | | | |
| Recalculated as | 6 ppm | 4 ppm | >10 ppm | 10 ppm |
| fines bleaching | | | | |
| earth | | | | |

*Taste descriptions were quantified by giving a score to a given taste intensity, numbers indicate number of testers
0 = no taste
1 = very weak fishy
2 = weak fishy
3 = fishy
4 = strongly fishy

Examples 1-4 show that the presence of bleaching earth fines in commercial oils leads to the formation of off-taste

### Example 5

Degummed and neutralized tuna fish oil is pumped into a vessel and bleached at a temperature of 90° C. Filtration is started immediately after the bleaching has finished. The bleaching steps and conditions are given in table 2.

TABLE 2
Bleaching steps description and conditions

| | | |
|---|---|---|
| | | Water content |
| Step | Amount | (wt. %) |

| | | | |
|---|---|---|---|
| pump oil in vessel | 400 | kg | 0.08 |
| Heat the oil to 90° C. under 100 | | | 0.033 |
| mbar vacuum and maintain for 10 | | | |
| minutes. Bring to atmospheric | | | |
| pressure | | | |
| Add 0.1% citric acid (50% | 0.4 | kg | 0.08 |
| solution) and stir for 15 | | | |
| minutes | | | |
| Add 0.15% demi water and stir | 0.6 | kg | 0.15 |
| for 15 minutes | | | |
| Add 4% bleaching earth | 16 | kg | |
| Stir for 20 minutes (wet | | | 0.125 |
| bleaching) | | | |
| Gradually apply vacuum to 100- | | | 0.09 |
| 200 mbar and check the water | | | (at 150 mbar) |
| content (Karl Fisher). The water | | | |
| content must be 0.1% ± 0.04 | | | |
| Hold condition for 20 minutes and | | | |
| start filtration | | | |

### Filtration

The filtration is carried out in a vertical leaf filter. A security filter is installed being a GAF bag (Hayward type F5844489) having a pore size of 25 μm.

The filtration process exists of 3 separate steps:
black run (oil+bleaching earth is recirculated over the filter until the turbidity meter shows the turbidity is below 0.2 FTU)
main filtration (all filtered oil is below 0.2 FTU)
rest filtration (filter will be emptied, the risk for particles is high)

FTU values were determined as described before.

The oil from the main filtration passes the security filter.

The critical parameter is turbidity of the filtrate and is monitored continuously.

TABLE 3
Filtration conditions: steps and turbidity values

| | Turbidity |
|---|---|
| Step | (FTU) |
| start blackrun | — |
| 5 minutes | 5 |
| 15 minutes | 0.5 |
| 25 minutes | 0.1 |
| main filtration t = 10 | 0.1 |
| main filtration t = 40 | 0.1 |
| filter emptying (material not used for main | >5 |
| filtration)will be used for 2^{nd} production | |
| filtertank containing the filtrate | 0.2 |

The critical turbidity is 0.2 FTU. Oils with higher values require polish filtration prior to the deodorization.

### Deodorisation/Polish Filtration

The oils/concentrates to be deodorized are now virtually free of bleaching earth residues and is ready to be deodorized. The process of deodorization can be divided into three parts:
heating and degassing stage
the deodorizing stage in which a required vapour volume passes the oil. At 180° C. the estimated volume amounts
the cooling/stage

The filter housing is joined to the deodorizer. It is very practical to carry out the polishing step during emptying of the deodorizer. The polish filter exists of a housing and a cartridge with a folded polypropylene filtersheet of 1 μm pore size.

TABLE 4
Deodorisation conditions: steps and temperatures

| Step | Temp ° C. |
|---|---|
| fill deodorizer | 40 |
| heat up and degas with N₂ | 80 |
| change from N2 to steam stripping | 110 |
| heat to setpoint | 180 |
| maintain condition for 5 h | 180 |
| cool, change from steamstripping to N₂ | 110 |
| add 20 mg citric acid as 50% solution | 90 |
| pressurize deodorizer very carefully | 90 |
| collect oils in drum via the polish | 60 |
| filter | |

The oil thus obtained is has a very low turbidity (<0.1 FTU) and has superior taste and taste keepability.

### Example 6

In a series of experiments seven fish oil blends were refined and the fresh taste was evaluated using the score list from 0-4. Each blend contained at least 50% fish concentrate of at least 40% EPA+DHA concentration making a final concentration of ˜20% EPA+DHA.

The fish blends were bleached using the wet/dry procedure and filtered. No precautions were taken to prevent bleaching fines could pass the filter. And also no second (polish) filtration was carried out. As a result some bleaching fines may or may not pass. All oils looked visually clear and transparent indicating that the filtration was successful. The oils were subjected to a standard deodorization as earlier described. The samples were tasted immediately after the deodorization step. The results are given in table 5.

TABLE 5
taste scores of fish blends after normal filtration and deodorization

| | turbidity (ftu) | |
|---|---|---|
| | after | fresh taste |
| blend type | main filtration | score |
| fish blend1 | 0.55 | 2 |
| fish blend2 | 0.8 | 3 |
| fish blend3 | 0.55 | 1 |
| fish blend4 | 2.5 | 3 |
| fish blend5 | 0.5 | 1 |
| fish blend6 | <0.1 | 0 |

The results show that out of 7 only 1 has no fish taste as evidenced by score 0. In 2 samples a some fish taste was perceived (score 1), three samples had an unacceptable fishy taste (score 2 or 3).

The same fish blends were subjected to a polish filtration to ensure the removal of bleaching fines. Thereafter the blends were deodorized and tasted. Table 6 depicts the results.

TABLE 6
taste scores of fish blends after polish filtration and deodorization

| | turbidity | |
|---|---|---|
| | (ftu) | |
| | after polish | taste |
| blend type | filtration | score |
| fish blend1 | <0.1 | 0 |
| fish blend2 | <0.1 | 0 |
| fish blend3 | <0.1 | 0 |
| fish blend4 | <0.1 | 0 |
| fish blend5 | <0.1 | 0 |
| fish blend6 | <0.1 | 0 |

The results of table 6 clearly demonstrate the effect of the removal of the bleaching fines. All blends had no bleaching fines and no fishy taste.

1. Process for the preparation of vulnerable oil wherein degummed and neutralised vulnerable oil is subjected to bleaching and thereafter subjected to filtration, characterized in that the filtration is conducted until the filtrate has a turbidity of 0.2 FTU or less.

2. Process according to claim 1, comprising one or more, preferably two or more, more preferably three or more and most preferably all four of the following steps a)-d):
a) bleaching involves both a wet step and a dry step
b) filtration is conducted in re-circulation until the filtrate has a turbidity of 0.2 FTU or less, preferably 0.1 FTU or less, before filtration of the vulnerable oil is commenced
c) after filtration the vulnerable oil is subjected to a second filtration to a turbidity of 0.1 FTU or less
d) the deodorization is conducted at a temperature of 190° C. or less until 5-20, preferably 8-20 m3 gas/kg oil is passed through the vulnerable oil.

3. Process according to claim 1, wherein the vulnerable oil is fish oil and/or marine oil/and or microbial oil or a concentrate thereof.

4. Process according to claim 2, wherein step c is included.

5. Process according to claim 4, wherein the second filtration is conducted with a polish filter having a pore diameter of 0.1-5 micrometer.

6. Process according to claim 2, wherein step a is present and wherein the wet step is conducted in the presence of 0.04-0.14 wt. % water.

7. Process according to claim 6, wherein in the wet step after addition of the 0.04-0.14 wt. % water, 0.02-0.07 wt. % citric acid as citric acid solution in water is added.

8. Process according to 2, wherein step d is present and wherein said step is conducted using a steam flow through the vulnerable oil.

9. Process according to claim 8, wherein the steam flow is a flow of superheated steam produced by the evaporation of de-mineralized water, which has been stripped with nitrogen.

10. Process according to claim 8, wherein after the steam flow is stopped, 10-30 mg/kg oil of citric acid, preferably as a solution in water, is added to the deodorized oil, when the oil has a temperature of 80-110° C.

11. Process according to claim 8, wherein after steam flow is stopped, nitrogen of at least 99.9% purity is flushed through the vulnerable oil.

12. Process according to claim 1, wherein the process is conducted batch-wise.
